(19) United States
(12) Patent Application Publication
(10) Pub. No.: US 2010/0247339 A1
(43) Pub. Date: Sep. 30, 2010

(54) NOISE-ATTENUATING DEVICE FOR HVAC AND REFRIGERATION SYSTEMS

(76) Inventor: Carlos Henrique Lagemann, Canoas (BR)

Correspondence Address: CARLSON, GASKEY & OLDS, P.C., 400 WEST MAPLE ROAD, SUITE 350, BIRMINGHAM, MI, 48009, US

(21) Appl. No.: 12/682,924

(22) PCT Filed: Dec. 27, 2007
(86) PCT No.: PCT/BR07/00362

§ 371 Date: Apr. 14, 2010

(51) Int. Cl. F04B 53/00; E04F 17/04; G10K 11/16

(52) U.S. Cl. 417/312; 181/224

(57) ABSTRACT

A noise-attenuating device for an HVAC and refrigeration system is provided. The HVAC and refrigeration system includes a condenser and at least one fan system. The noise-attenuating device includes an inner shell with a first outer surface, a first inner surface and a layer of a noise-absorbent material enclosed between the first outer surface and the first inner surface. The noise-attenuating device also includes an outer shell with a second outer surface, a second inner surface, and a layer of the noise-absorbent material enclosed between the second outer surface and the second inner surface. The noise generated in the condenser is minimized by using the noise-attenuating device.

### FIELD OF THE INVENTION

The invention generally relates to the field of Heating, Ventilation, Air Conditioning (HVAC) and refrigeration systems. More specifically, the invention relates to a device for attenuating noise in HVAC and refrigeration systems.

### BACKGROUND OF THE INVENTION

HVAC and refrigeration systems have applications in various domestic, industrial and commercial areas. Examples of HVAC and refrigeration systems include, but are not limited to, chillers, air handlers, and variable air volume terminal units.

For adequate cooling of large cooling spaces such as buildings, large capacity HVAC and refrigeration systems are used. Such HVAC and refrigeration systems typically include a compressor, a condenser, and an evaporator. Typically a scroll rotary compressor or a reciprocating compressor is used. The compressor functions to compress a refrigerant, which is then circulated through a condenser coil. A fan blows air across the condenser coil. The amount of cooling that is provided depends on various factors, such as the speed of the fans, and the number of fans used.

When the speed of the compressor is increased, the corresponding flow rate of the compressed refrigerant is increased. Therefore, to cool the refrigerant at an increased rate, a higher rate of heat exchange by the condenser is required. This rate of heat exchange can be augmented by increasing the flow of air blown over the condenser coil, which can be achieved by increasing the speed of the fan, or by increasing the number of fans. An increase in the speed of the fan, or the number of fans, increases the noise generated by the sound of fan and motor; and flow of air in the HVAC and refrigeration system. The high noise may be uncomfortable for the users of the HVAC and refrigeration system. Various methods are employed to reduce the noise generated in HVAC and refrigeration systems.

One such method or apparatus is the provision of acoustic enclosures. An acoustic enclosure is an enclosed space that is created around the source of the noise. The acoustic enclosure may include walls, and a roof, that are created around the source of the noise. The amount of noise attenuation provided by acoustic enclosures depends on the frequency of the noise, the material used in the construction of walls, and the quality of construction. The construction of an efficient acoustic enclosure entails high cost of manufacturing, and results in an increase in the energy consumption of the fans, which causes the performance of the HVAC and refrigeration system to deteriorate. Further, construction of such an acoustic enclosure complicates the design, installation, operation, and maintenance of the HVAC and refrigeration system.

Another method or apparatus involves the provision of louvers for the HVAC and refrigeration system. Louvers are, typically, frames with horizontal and vertical slats angled to admit air inside the condenser, and also limit the noise. However, the use of louvers has a specific disadvantage which is a drop in the air pressure. This drop in the air pressure results in an increase in the energy consumption of the fans, which causes the performance of the HVAC and refrigeration system to deteriorate.

In light of the foregoing facts, there exists a need for providing a device for attenuating noise in an HVAC and refrigeration systems. The device should be easy to design, should not entail high installation, operation or maintenance costs. Further, the device should enable easy access for the maintenance of HVAC and refrigeration systems. Moreover, the system should not result in a significant drop in the air pressure in such systems.

### SUMMARY

Embodiments of the invention provide a noise-attenuating device for an HVAC and refrigeration system. The HVAC and refrigeration system includes a condenser and at least one fan system. The noise-attenuating device includes an inner shell with a first outer surface, a first inner surface and a layer of a noise-absorbent material that is enclosed between the first outer surface and the first inner surface. The noise-attenuating device also includes an outer shell that has a second outer surface, a second inner surface, and a layer of the noise-absorbent material that is enclosed between the second outer surface and the second inner surface.

Embodiments of the invention provide a condensing unit for an HVAC and refrigeration system. The condensing unit includes a condenser that includes a condensing coil, at least one fan system that is configured to circulate air across the condenser coil, and a noise-attenuating device. The noise-attenuating device includes a first outer surface, a first inner surface and a layer of a noise-absorbent material that is enclosed between the first outer surface and the first inner surface. The noise-attenuating device is configured to house the at least one fan system. The noise generated by the air circulated by the fan system in the condenser is minimized by using the noise-attenuating device.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 illustrates a condensing unit of an HVAC and refrigeration system, in accordance with an embodiment of the present invention;

FIG. 2 illustrates cross-section view of a noise-attenuating duct of an HVAC and refrigeration system, in accordance with an embodiment of the present invention; and

FIG. 3 illustrates a cross sectional view of a condensing unit of the HVAC and refrigeration system with noise-attenuating duct installed, in accordance with an embodiment of the present invention.

### DESCRIPTION OF EMBODIMENTS

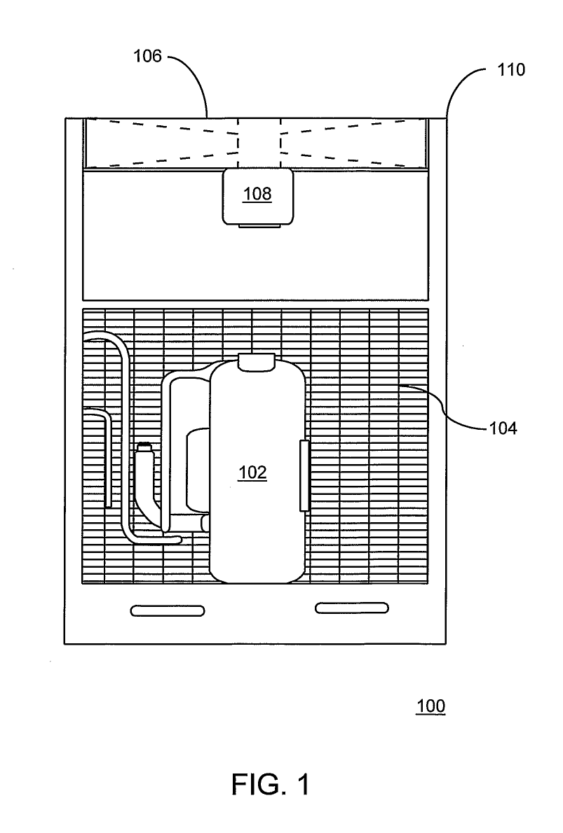

FIG. 1 illustrates a condensing unit 100 of an HVAC and refrigeration system, in accordance with an embodiment of the invention. Condensing unit 100 includes a compressor 102, a condenser coil 104, a fan 106, and a motor 108. Examples of compressor 102 include, but are not limited to, a scroll compressor, rotary compressor, reciprocating and carbon dioxide compressor. Compressor 102 compresses a refrigerant in the HVAC and refrigeration system. As a result, the pressure and temperature of the refrigerant are increased. Subsequently, the refrigerant is expanded in a condenser. The pressurized refrigerant is circulated through condenser coil 104. Air is blown over condenser coil 104 by using fan 106 to exchange heat with the air.

Fan 106 is supported by a body 110 of condensing unit 100. During the working of condensing unit 100, the operation of fan 106 causes air to flow across condenser coil 104, and through the passages formed by body 110. The flow of air through the passage generates acoustic sounds. With the increase in the rate of air flow, the intensity of sound increases. This results in an undesirable noise.

A noise-attenuating device is used to minimize the undesirable noise produced in condensing unit 100. In an embodiment of the invention, the noise-attenuating device is a duct. Hereinafter, the ‘noise-attenuating device’ is referred to as the ‘noise-attenuating duct’.

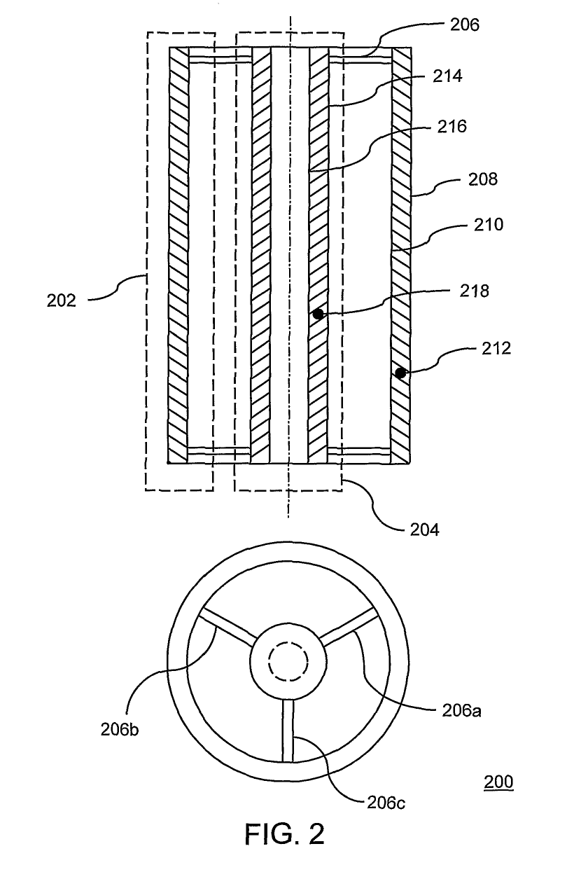

FIG. 2 illustrates cross-section view of a noise-attenuating duct of an HVAC and refrigeration system, in accordance with an embodiment of the invention. In an embodiment of the invention, noise-attenuating duct 200 includes an outer shell 202 and an inner shell 204. Inner shell 204 is concentric to outer shell 202. Inner shell 204 is attached to outer shell 202 by a support 206. In another embodiment of the invention, support 206 includes arms 206a, 206b and 206c. It will be apparent to a person skilled in the art that the arrangements and number of arms shown here are only for illustrative purposes. They do not restrict the scope of the invention in any way. Numerous other arrangements for attaching inner shell 204 to outer shell 202 are also possible.

In an embodiment of the invention, the length of inner shell 204 is equal to that of outer shell 202. It will be apparent to a person skilled in the art that the orientation and length of inner shell 204 with respect to outer shell 202 have been mentioned here for illustrative purpose only. They do not, in any way, restrict the scope of the invention, which is equally applicable to other orientations and lengths of inner shell 204 and outer shell 202. In another embodiment of the invention, inner shell 204 is smaller in length than outer shell 202.

Outer shell 202 includes a first outer surface 208, a first inner surface 210, and a layer of a noise-absorbent material 212. First outer surface 208 is parallel to first inner surface 210. In an embodiment of the invention, first outer surface 208 is inclined at an angle to first inner surface 210. The layer of noise-absorbent material 212 is enclosed between first outer surface 208 and first inner surface 210. In an embodiment of the invention, the material of noise-absorbent material 212 is rock wool. In various embodiments of the invention, mineral glass, fiber, and various foams are used as noise-absorbent material 212. It should be noted that any other material with a noise absorbent property can also be used as noise-absorbent material 212.

Inner shell 204 includes a second outer surface 214, a second inner surface 216, and a layer of noise-absorbent material 218. Second outer surface 214 is parallel to second inner surface 216. The layer of noise-absorbent material 218 is enclosed between second outer surface 214 and second inner surface 216. In an embodiment of the invention, the material of noise-absorbent material 218 is rock wool. In various embodiments of the invention, mineral glass, fiber, and various foams are used as noise-absorbent material 218. It should be noted that any other material with a noise absorbent property can also be used as noise-absorbent material 218.

In an embodiment of the invention, first outer surface 208, first inner surface 210, second outer surface 214 and second inner surface 216 are made of a metal alloy such as stainless steel. However, any other metal or a metal alloy, or any other suitable material for enclosing the layers of noise-absorbent materials 212 and 218 can also be used.

In an embodiment of the invention, noise-attenuating duct 200 is used as a suction duct for condensing unit 100 of the HVAC and refrigeration system. In another embodiment of the invention, noise-attenuating duct 200 is used as a discharge duct of condensing unit 100 of the HVAC and refrigeration system. Noise-attenuating duct 200 is installed to minimize the noise generated by the sound of fan 106 and motor 108 and the flow of air inside condensing unit 100.

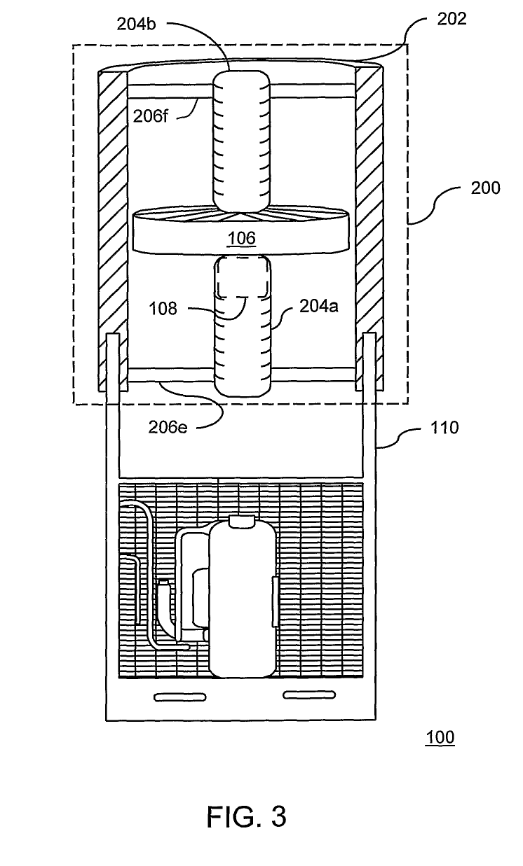

FIG. 3 illustrates a cross sectional view of a condensing unit 100 with noise-attenuating duct 200 installed, of the HVAC and refrigeration system, in accordance with an embodiment of the invention. Outer shell 202 is fitted on body 110 of condensing unit 100. In an embodiment of the invention, a groove is formed in outer shell 202, to fit noise-attenuating duct 200 on body 110. Alternatively, a nut and bolt arrangement can be used. It will be apparent to a person skilled in the art that the arrangements of fitting outer shell 202 to body 110 mentioned here are for illustrative purpose only. Various other arrangements of fitting outer shell 202 to body 110 can be used.

In an embodiment of the invention, noise-attenuating duct 200 includes inner shell 204 that is placed inside outer shell 202. The orientation of inner shell 204 can be concentric with respect to outer shell 202. Inner shell 204 includes a lower duct 204a and an upper duct 204b. Lower duct 204a houses motor 108. Upper duct 204b is placed above fan 106. The base of upper duct 204b is fitted on the central part of fan 106. Support 206e attaches lower duct 204a to outer shell 202. Similarly, support 206f attaches upper duct 204b to outer shell 202. By using the arrangement described above, the fan system, which includes fan 106 and motor 108, is supported inside noise-attenuating duct 200. As described in conjunction with FIG. 2, an arrangement of three or more arms can be used for supports 206e and 206f.

In an embodiment of the invention, a suction duct is placed to cover the suction side of fan 106, to minimize the noise generated by fan 106 and motor 108; and the air taken in condensing unit 100. A discharge duct is placed to cover the discharge side of fan 106, to minimize the noise generated by fan 106 and motor 108; and the air coming out of condensing unit 100. The suction duct and the discharge duct together form noise-attenuating duct 200 for condensing unit 100.

The amount of noise attenuation is directly proportional to the length of noise attenuating duct 200. In an embodiment of the invention, the length of noise attenuating duct 200 is increased. The increase in the length results in higher noise attenuation.

Embodiments of the invention offer one or more of the following advantages. The noise-attenuating device is easy in design, and is a cost-effective solution for reduction of noise in HVAC and refrigeration systems. It does not entail high cost of installation, operation or maintenance. Further, the noise-attenuating device enables an easy maintenance of HVAC and refrigeration systems. Moreover, the noise-attenuating device does not result in a significant drop in the air pressure in HVAC and refrigeration systems.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

1. A noise-attenuating device for an HVAC system comprising:
a first outer surface;
a first inner surface; and
a layer of a noise-absorbent material, wherein the layer of the noise-absorbent material is enclosed between the first outer surface and the first inner surface.

2. The noise-attenuating device according to claim 1, wherein the first inner surface and the first outer surface are concentric.

3. The noise-attenuating device according to claim 1 further comprising:
a second outer surface;
a second inner surface; and
a layer of the noise-absorbent material, wherein the layer of the noise-absorbent material is enclosed between the second outer surface and the second inner surface.

4. The noise-attenuating device according to claim 3, wherein the second inner surface and the second outer surface are concentric.

5. The noise-attenuating device according to claim 1, wherein the HVAC system comprises a fan system, which comprises a fan for circulating air and a motor configured to drive the fan.

6. The noise-attenuating device according to claim 5, wherein the noise-attenuating device encloses the fan system.

7. The noise-attenuating device according to claim 1, wherein the noise-attenuating device is a suction duct.

8. The noise-attenuating device according to claim 1, wherein the noise-attenuating device is a discharge duct.

9. A condensing unit for an HVAC system, comprising:
a condenser comprising a condensing coil;
at least one fan system configured to circulate air across the condenser coil;
a noise-attenuating device comprising:
a first outer surface;
a first inner surface; and
a layer of a noise-absorbent material enclosed between the first outer surface and the first inner surface;
wherein the noise-attenuating device is configured to house the at least one fan system.

10. The condensing unit according to claim 9, wherein the first inner surface and the first outer surface are concentric.

11. The condensing unit according to claim 9, wherein the noise-attenuating device further comprises:
a second outer surface;
a second inner surface; and
a layer of the noise-absorbent material enclosed between the second outer surface and the second inner surface.

12. The condensing unit according to claim 11, wherein the second inner surface and the second outer surface are concentric.

13. The condensing unit according to claim 9, wherein the at least one fan system comprises a fan for circulating air; and a motor configured to drive the fan.

14. The condensing unit according to claim 9, wherein the motor is housed inside the second inner surface.

15. The condensing unit according to claim 9, wherein the noise-attenuating device is a suction duct.

16. The condensing unit according to claim 9, wherein the noise-attenuating device is a discharge duct.

17. The condensing unit according to claim 9, wherein the noise-absorbent material is rock wool.

18. The condensing unit according to claim 9, wherein the noise-absorbent material is selected from the group of materials comprising mineral wool, glass fiber and foam.

19. A noise-attenuating device for an HVAC and refrigeration system, the HVAC and refrigeration system comprising a condenser and at least one fan system, the device comprising:
an outer shell configured to function as a duct for the condenser, the outer shell comprising a first outer surface, a first inner surface and a layer of a noise-absorbent material enclosed between the first outer surface and the first inner surface; and
an inner shell configured to function as an enclosure for the at least one fan system, the inner shell comprising a second outer surface, a second inner surface and a layer of the noise-absorbent material enclosed between the second outer surface and the second inner surface.
